(19) United States
(12) Patent Application Publication
(10) Pub. No.: US 2022/0041013 A1
(43) Pub. Date: Feb. 10, 2022

(54) TIRE PROVIDED WITH AN OUTER SIDEWALL, THE COMPOSITION OF WHICH COMPRISES A DERIVATIVE OF POLYETHYLENE OXIDE

(71) Applicant: COMPAGNIE GENERALE DES ETABLISSEMENTS MICHELIN, Clermont-Ferrand (FR)

(72) Inventors: FABIEN HELLOT, Clermont-Ferrand (FR); SYLVAIN MAYER, Clermont-Ferrand (FR)

(21) Appl. No.: 17/416,666

(22) PCT Filed: Dec. 18, 2019
(86) PCT No.: PCT/FR2019/053153

§ 371 Date: Jun. 21, 2021

(30) Foreign Application Priority Data
Dec. 21, 2018 (FR) 1873932
Jan. 31, 2019 (FR) 1900917

(51) Int. Cl. B60C 1/00; C08K 3/04; C08L 9/00

(52) U.S. Cl. CPC B60C 1/0025; C08L 71/02; C08L 9/00; C08K 3/04

(57) ABSTRACT

A tire is provided with an external sidewall, the said external sidewall comprising at least one composition based on at least from 15 to 70 phr of isoprene elastomer, from 25 to 85 phr of butadiene elastomer, from 10 to 100 phr of carbon black, from 0.75 to 2.7 phr of polyethylene oxide derivative of general formula (Chem 1) below, in which n is a number within a range extending from 20 to 25, and m is a number within a range extending from 13 to 17, from 0.5 to 10 phr of antiozone wax, and a crosslinking system

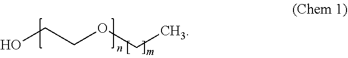

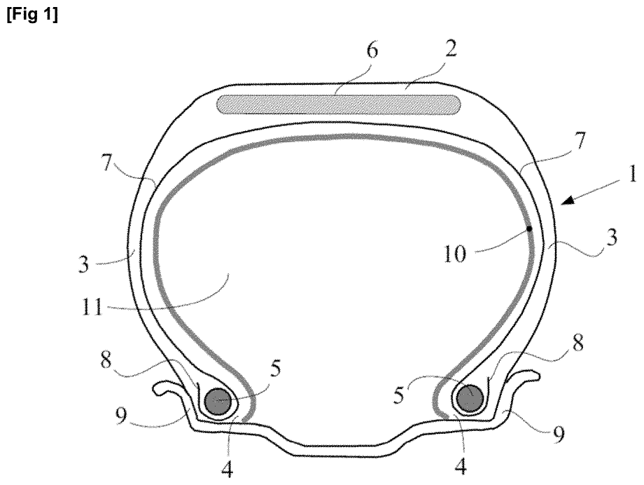

The present invention relates to pneumatic tyres and more particularly to tyre external sidewalls, that is to say, by definition, to the elastomeric layers located radially on the outside of the tyre, which are in contact with the ambient air.

This is because it is possible to define, within the tyre, three types of regions:
The radially exterior region in contact with the ambient air, this region being essentially composed of the tread and of the external sidewall of the tyre. An external sidewall is an elastomeric layer positioned outside the carcass reinforcement with respect to the internal cavity of the tyre, between the crown and the bead, so as to completely or partially cover the region of the carcass reinforcement extending from the crown to the bead.
The radially interior region in contact with the inflation gas, this region generally being composed of the layer airtight to the inflation gases, sometimes known as inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

As illustrated by numerous documents, among which may be mentioned the documents EP1097966, EP1462479B1, EP1975200 Al, EP1033265B1, EP1357149A2, EP1231080A1 and U.S. Pat. No. 4,824,900, the compositions conventionally used for sidewalls are based on natural rubber and on synthetic rubber, such as polybutadiene, and on carbon black.

For tyre manufacturers, the composition of a tyre sidewall has to exhibit numerous characteristics which are sometimes difficult to reconcile and in particular a good ozone resistance. A known solution is to add an antiozone wax to the composition. However, the antiozone wax exhibits the disadvantage of migrating towards the outside of the sidewalls, resulting in the appearance of whitish stains which damage the attractiveness of the tyres. This phenomenon is known as efflorescence. It is thus advantageous for tyre manufacturers to have available sidewall compositions exhibiting the technical properties of ozone resistance, without the efflorescence damaging the attractiveness of the tyre sidewalls. In order to reduce the efflorescence, one known solution consists in adding polyols, such as polypropylene glycols or polyethylene glycols, which are functionalized. However, such additives tend to migrate excessively during the storage and the use of the tyre, so that the surface becomes tacky and greasy to the touch.

The document EP 1097966A1 describes the use of certain polyethylene oxide derivatives, comprising from 2 to 15 polyethylene oxide units, for improving the colouration phenomena. However, the solutions provided in this document can still be improved, in particular for making possible the use of a greater amount of wax in the compositions and thus better protection from attacks of ozone on the tyres.

In this context, a solution introduced by the Applicant Companies which makes it possible to obtain tyres which exhibit the technical, aesthetic and touch properties discussed above consists in using novel sidewall compositions as explained below.

A subject-matter of the invention proposed is now a tyre provided with an external sidewall, the said external sidewall comprising at least one composition based on at least from 15 to 70 phr of isoprene elastomer, from 25 to 85 phr of butadiene elastomer, from 10 to 100 phr of carbon black; from 0.75 to 2.7 phr of polyethylene oxide derivative of general formula (Chem 1) below, in which n is a number within a range extending from 20 to 25, and m is a number within a range extending from 13 to 17; from 0.5 to 10 phr of antiozone wax, and a crosslinking system.

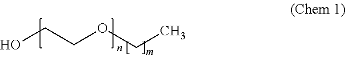

The invention relates more particularly to the pneumatic tyres intended to equip motor vehicles of passenger vehicle type, SUVs (“Sport Utility Vehicles”), or two-wheel vehicles (in particular motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or earthmoving equipment—, and other transportation or handling vehicles.

The invention and its advantages will be easily understood in the light of the description and implementational examples which follow, and also of the single figure relating to these examples, which diagrammatically represents, in radial cross section, a pneumatic tyre in accordance with the invention.

The expression “composition based on” should be understood as meaning a composition comprising the mixture and/or the product of the in situ reaction of the various base constituents used, some of these constituents being able to react and/or being intended to react with one another, at least partially, during the various phases of manufacture of the composition or during the subsequent curing, modifying the composition as it is prepared at the start. Thus, the compositions as employed for the invention can be different in the non-crosslinked state and in the crosslinked state.

Moreover, the term “phr” means, within the meaning of the present patent application, parts by weight per hundred parts of elastomers, in a way well known to a person skilled in the art.

In the present description, unless expressly indicated otherwise, all the percentages (%) shown are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant polymer is the polymer representing the greatest weight, with respect to the total weight of the polymers in the composition. In the same way, a “predominant” filler is the one representing the greatest weight among the fillers of the composition. By way of example, in a system comprising just one polymer, the latter is predominant within the meaning of the present invention and, in a system comprising two polymers, the predominant polymer represents more than half of the weight of the polymers. On the contrary, a “minor” compound is a compound which does not represent the greatest fraction by weight among the compounds of the same type.

Within the meaning of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer). Thus, for example, a resin predominantly composed of units resulting from C₅ monomers is a resin in which the C₅ units represent the greatest amount by weight among all the units making up the said resin. In other words, a “predominant” monomer or an assembly of “predominant” monomers is a monomer (or an assembly of monomers) which represents the greatest fraction by weight in the polymer. On the contrary, a “minor” monomer is a monomer which does not represent the greatest molar fraction in the polymer.

The compounds mentioned in the description can be of fossil or biobased origin. In the latter case, they can partially or completely result from biomass or be obtained from renewable starting materials resulting from biomass. Polymers, plasticizers, fillers, and the like, are concerned in particular.

External Sidewall Elastomer Composition

The tyre according to the invention has the essential characteristic of being provided with an external sidewall, the said external sidewall comprising at least one composition based on at least from 15 to 70 phr of isoprene elastomer, from 25 to 85 phr of butadiene elastomer, from 10 to 100 phr of carbon black; from 0.75 to 2.7 phr of polyethylene oxide derivative of general formula (Chem 1) below, in which n is a number within a range extending from 20 to 25, and m is a number within a range extending from 13 to 17; from 0.5 to 10 phr of antiozone wax, and a crosslinking system.

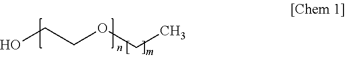

Elastomers

As is customary, the terms “elastomer” and “rubber”, which are interchangeable, are used without distinction in the text.

“Diene” elastomer or rubber should be understood, in a known way, as meaning an (one or more is understood) elastomer resulting at least in part (i.e.; a homopolymer or a copolymer) from diene monomers (monomers carrying two conjugated or non-conjugated carbon-carbon double bonds).

These diene elastomers can be classified into two categories: “essentially unsaturated” or “essentially saturated”.

“Essentially unsaturated” is generally understood to mean a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood in particular to mean a diene elastomer having a content of units of diene origin (conjugated dienes) which is greater than 50% (mol %).

Thus it is that diene elastomers such as some butyl rubbers or copolymers of dienes and of α-olefins of EPDM type can be described as “essentially saturated” diene elastomers (low or very low content of units of diene origin, always less than 15 mol %).

Given these definitions, essentially unsaturated diene elastomer capable of being used in the external sidewalls in accordance with the invention is understood more particularly to mean:

(a) any homopolymer obtained by polymerization of a conjugated diene monomer having from 4 to 12 carbon atoms;

b) any copolymer obtained by copolymerization of one or more conjugated dienes with one another or with one or more vinylaromatic compounds having from 8 to 20 carbon atoms.

For the requirements of the invention, the composition of the external sidewall comprises from 15 to 70 phr of isoprene elastomer and from 25 to 85 phr of butadiene elastomer.

Isoprene elastomer is understood to mean all the elastomers predominantly composed of isoprene monomers. Preferably, the isoprene elastomer is selected from the group consisting of isoprene polymers, isoprene copolymers and their mixtures. Among isoprene copolymers, mention may be made of those comprising, as minor comonomer, styrene (SIR), butadiene (BIR) or styrene and butadiene (SBIR).

Suitable, for example, are all isoprene/styrene copolymers and in particular those having a styrene content of between 5% and 50% by weight and a Tg of between −25° C. and −50° C.; also suitable are butadiene/isoprene copolymers having an isoprene content of between 50% and 90% by weight and a Tg of −40° C. to −80° C. In the case of butadiene/styrene/isoprene copolymers, suitable as isoprene elastomer are those having an isoprene content which is greater than the styrene and butadiene content, and in particular those having an isoprene content of between 50% and 60% by weight.

More preferably, the isoprene elastomer is selected from the group consisting of natural rubber (NR), synthetic polyisoprenes (IR) and their mixtures. Very preferably, the isoprene elastomer is natural rubber.

Use is preferably made, among synthetic polyisoprenes, of polyisoprenes having a content (mol %) of cis-1,4-bonds of greater than 90%, more preferably still of greater than 98%.

Preferably, the content of isoprene elastomer is within a range extending from 30 to 60 phr, preferably from 35 to 50 phr.

Butadiene elastomer is understood to mean all the elastomers predominantly composed of butadiene monomers. Preferably, the butadiene elastomer is selected from the group consisting of butadiene polymers, butadiene copolymers and their mixtures. Among butadiene copolymers, mention may be made of those comprising, as minor comonomer, styrene (SBR), isoprene (BIR) or styrene and isoprene (SBIR).

All polybutadienes are suitable and in particular those having a content (mol %) of 1,2-units of between 4% and 80% or those having a cis-1,4-content (mol %) of greater than 80%.

Also suitable are all butadiene/styrene copolymers and in particular those having a glass transition temperature, Tg, (measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%.

Also suitable are butadiene/isoprene copolymers, those having an isoprene content between 5% and 50% by weight and a Tg of −40° C. to −80° C. In the case of butadiene/styrene/isoprene copolymers, suitable as butadiene elastomer are in particular those having a butadiene content which is greater than the styrene and isoprene content.

More preferably, the butadiene elastomer is selected from the group consisting of polybutadiene (BR), butadiene/styrene copolymers (SBRs) and their mixtures. Very preferably, the butadiene elastomer is polybutadiene.

Preferably, the content of butadiene elastomer is within a range extending from 40 to 70 phr, preferably from 50 to 65 phr.

Preferably, for the invention, the isoprene and butadiene elastomers are the only elastomers of the composition, which means that the sum of their contents in phr is 100 phr.

Alternatively, complementarily, the composition of the external sidewall of the tyre of the invention can comprise other elastomers, this being the case at a content preferably of less than or equal to 30 phr, preferably at a content of less than or equal to 25 phr, 20 phr, indeed even 15 phr.

Use may be made, as such, of any elastomer known to a person skilled in the art which is not defined above as isoprene or butadiene elastomer.

Carbon Black and Fillers

The composition of the external sidewall of the tyre of the invention comprises from 10 to 100 phr of carbon black.

Use may be made of any type of carbon black known for its abilities to reinforce a rubber composition which can be used in the manufacture of tyres.

All the carbon blacks conventionally used in tyres (“tyre-grade” blacks) are suitable as carbon blacks. Mention will more particularly be made, for example, of the reinforcing carbon blacks of ASTM grade N115, N134, N234, N326, N330, N339, N347 or N375, or else, depending on the applications targeted, the blacks of higher series (for example N550, N660, N683 or N772), indeed even N990.

In the case of the use of carbon blacks with an isoprene elastomer, the carbon blacks might, for example, be already incorporated in the isoprene elastomer in the form of a masterbatch (see, for example, Applications WO 97/36724 or WO 99/16600).

Preferably, for the invention, use may be made of a carbon black having a high specific surface. Specific surface is understood here to mean the BET specific surface measured according to Standard ASTM D6556-09 [multipoint (5 point) method—gas: nitrogen—relative pressure p/po range: 0.05 to 0.30].

Thus, for the requirements of the invention, in the composition of the external sidewall, from 10 to 100 phr of the carbon black, preferably from 10 to 45 phr, exhibits a specific surface of greater than 60 m²/g, preferably of greater than 80 m²/g. More preferably, from 10 to 100 phr of the carbon black, preferably from 10 to 45 phr, exhibits a specific surface of greater than 90 m²/g, preferably of greater than 110 m²/g.

Preferably, in the composition of the external sidewall of the tyre of the invention, the total amount of carbon black is within a range extending from 20 to 60 phr, preferably from 25 to 55 phr.

Preferably, for the invention, the carbon black is the only reinforcing filler in the composition of the external sidewall of the tyre, preferably the only filler.

Alternatively and complementarily, the composition of the external sidewall of the tyre of the invention can comprise another filler, optionally a reinforcing filler, preferably at a total content of less than 20 phr, more preferably of less than 15 phr.

Suitable as such are organic fillers other than carbon black, reinforcing inorganic fillers or also non-reinforcing fillers.

Mention may be made, as examples of organic fillers other than carbon blacks, of functionalized polyvinylaromatic organic fillers, such as are described in Applications WO-A-2006/069792 and WO-A-2006/069793.

Mineral fillers of the siliceous type, especially silica (SiO₂), or of the aluminous type, especially alumina (Al₂O₃), are suitable in particular as reinforcing inorganic fillers. The silica used can be any reinforcing silica known to a person skilled in the art, in particular any precipitated or fumed silica exhibiting a BET specific surface and also a CTAB specific surface both of less than 450 m²/g, preferably from 30 to 400 m²/g. Mention will be made, as highly dispersible precipitated silicas (“HDSs”), for example, of the “Ultrasil 7000” and “Ultrasil 7005” silicas from Degussa, the “Zeosil 1165MP, 1135MP and 1115MP” silicas from Rhodia, the “Hi-Sil EZ150G” silica from PPG, the “Zeopol 8715, 8745 and 8755” silicas from Huber or the silicas with a high specific surface as described in Application WO03/16837.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Mention may be made, as non-reinforcing filler, of those selected from the group consisting of calcium carbonate, kaolin, montmorillonite, aluminium silicate, magnesium silicate and their mixtures.

Polyethylene Oxide Derivative

The composition of the external sidewall of the tyre of the invention comprises from 0.75 to 2.7 phr of polyethylene oxide derivative of general formula (Chem 1) below, in which n is a number within a range extending from 20 to 25, and m is a number within a range extending from 13 to 17.

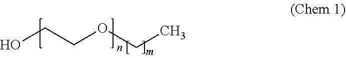

Preferably, in the polyethylene oxide derivative of general formula (Chem 1), n is a number within a range extending from 20 to 23; more preferentially, n is equal to 20.

Preferably, in the polyethylene oxide derivative of general formula (Chem 1), m is equal to 15.

The weight-average molecular weight (Mw) of the polyethylene oxide derivative of general formula (Chem 1) is preferably within a range extending from 1080 g/mol to 1412 g/mol, preferably from 1080 g/mol to 1200 g/mol.

This is because the Applicant Companies have found that such an amount of such a polyethylene oxide derivative made it possible for the tyre sidewall compositions to exhibit an excellent balance in performance qualities of ozone resistance, without deterioration in appearance or in touch, of the composition after curing. In comparison, other polyethylene oxide derivatives proved to be less effective, indeed even ineffective.

The polyethylene oxide derivatives of general formula (Chem 1) are surfactants. The solubility of any surface-active agent is characterized by its hydrophilic/lipophilic balance (HLB). The phase in which the emulsifier will be most soluble will form the continuous phase of the emulsion. A water-soluble emulsifier will stabilize an oil-in-water emulsion, and vice versa. The values of the HLB will be spaced out between 1 and 20, and the greater the HLB value, the more hydrophilic the emulsifier. Preferably for the invention, a polyethylene oxide derivative of general formula (Chem 1) will be chosen, the HLB value of which is greater than 14, preferably within a range extending from 14 to 20 and more preferentially between 15 and 17.

Such compounds are commercially available, such as polyoxyethylene (23) lauryl ether (“Brij 35” or “Brij L23”; HLB=16.9), ceteareth-20 (“Brij CS 20” or “Brij C20”, HLB=15.7), polyoxyethylene (25) ceteareth-25 “(Brij CS25”, HLB=16.2), polyoxyethylene (20) of C₁₃₋₁₅ alcohols (“Synperonic A20”, HLB=16.2), polyoxyethylene (20) stearyl (“Brij S20”, HLB=15.3).

Antiozone Wax

The composition of the external sidewall of the tyre of the invention comprises from 0.5 to 10 phr of antiozone wax.

Antiozone waxes are well known to a person skilled in the art. These film-forming antiozonant waxes can, for example, be paraffinic waxes, microcrystalline waxes or mixtures of paraffinic and microcrystalline waxes. They consist of a mixture of linear alkanes and of non-linear alkanes (isoalkanes, cycloalkanes, branched alkanes) resulting from the refining of oil or from the catalytic hydrogenation of carbon monoxide (Fischer-Tropsch process) predominantly comprising chains of at least 20 carbon atoms.

All the antiozonant waxes known to a person skilled in the art can be used, including natural waxes, such as, for example, candelilla wax or carnauba wax. These waxes can, furthermore, be used as blends.

Mention may be made of the commercial waxes “Varazon 4959” or “Varazon 6500” or also “Varazon 6810” from Sasol, “Ozoace 0355” from Nippon Seiro, “Negozone 9343” from H&R and “H3841” from Yanggu Huatai.

Preferably, the antiozone wax contains from 50% to 75% of linear alkanes comprising from 30 carbon atoms to 38 carbon atoms, with respect to the total amount of linear alkanes.

Preferably, in the composition of the external sidewall of the tyre of the invention, the amount of antiozone wax is within a range extending from 0.7 to 5 phr, more preferably from 0.7 to 3 phr. More preferably, the amount of antiozone wax is within a range extending from 0.9 to 3 phr, preferably from 1.2 to 2.8 phr.

Crosslinking System

The crosslinking system can be a vulcanization system; it is preferably based on sulfur (or sulfur donor) and on a primary vulcanization accelerator. Additional to this vulcanization system are optionally various known secondary vulcanization accelerators or vulcanization activators (preferably for 0.5 to 5.0 phr each), such as zinc oxide, stearic acid, guanidine derivatives (in particular diphenylguanidine), and the like. Sulfur or a sulfur donor is used at a preferred content of between 0.5 and 10 phr, more preferably of between 0.5 and 5.0 phr, for example between 0.5 and 3.0 phr, when the invention is applied to a tyre external sidewall. Mention may be made, among sulfur donors, for example, of alkylphenol disulfides (APDSs), such as, for example, para-(tert-butyl)phenol disulfide.

Use may be made, as (primary or secondary) accelerator, of any compound capable of acting as accelerator of the vulcanization of diene elastomers in the presence of sulfur, in particular accelerators of the thiazole type and their derivatives and accelerators of the thiuram and zinc dithiocarbamate types. These accelerators are more preferably selected from the group consisting of 2-mercaptobenzothiazyl disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBB S”), N-(tert-butyl)-2-benzothiazolesulfenimide (abbreviated to “TBSI”), zinc dibenzyldithiocarbamate (abbreviated to “ZBEC”) and the mixtures of these compounds. Preferably, use is made of a primary accelerator of the sulfenamide type.

Various Additives

The external sidewall composition described above can furthermore comprise the various additives normally present in the external sidewalls known to a person skilled in the art.

Mention will be made, for example, of protective agents, such as antioxidants or antiozonants, UV stabilizers, various processing aids or other stabilizers, or else promoters capable of promoting the adhesion to the remainder of the structure of the pneumatic object.

Plasticizers: Resin and Oil

The composition of the external sidewall of the tyre of the invention can additionally comprise a hydrocarbon resin, also known as plasticizing resin.

It is recalled here that the designation “resin” is reserved in the present patent application, by definition known to a person skilled in the art, for a compound which is solid at ambient temperature (23° C.), in contrast to a liquid plasticizing compound, such as an extender oil or plasticizing oil. At ambient temperature (23° C.), these oils, which are more or less viscous, are liquids (that is to say, as a reminder, substances which have the ability to eventually assume the shape of their container), in contrast in particular to resins or rubbers, which are by nature solids.

Hydrocarbon resins are polymers well known to a person skilled in the art, essentially based on carbon and hydrogen, which can be used in particular as plasticizing agents in polymer matrices. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). They are by definition miscible (i.e., compatible) at the contents used with the polymer compositions for which they are intended, so as to act as true diluents. Their Tg is preferably greater than 0° C., in particular greater than 20° C. (most often between 30° C. and 120° C.).

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

The thermoplastic hydrocarbon resins can be aliphatic or aromatic or also of the aliphatic/aromatic type, that is to say based on aliphatic and/or aromatic monomers. They can be natural or synthetic, based or not based on petroleum (if such is the case, also known under the name of petroleum resins).

Suitable as aromatic monomers are, for example, styrene, α-methylstyrene, ortho-, meta- or para-methyl styrene, vinyltoluene, para-(tert-butyl)styrene, methoxy styrenes, chlorostyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic monomer is styrene or a vinylaromatic monomer resulting from a C₉ fraction (or more generally from a C₈ to C₁₀ fraction). Preferably, the vinylaromatic monomer is the minor monomer, expressed as molar fraction, in the copolymer under consideration.

According to a particularly preferred embodiment, the plasticizing hydrocarbon resin is selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer and copolymer resins and the mixtures of these resins. The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Mention will in particular be made, among the above plasticizing hydrocarbon resins, of α-pinene, β-pinene, dipentene or polylimonene homo- or copolymer resins.

Very preferably, the hydrocarbon resin used for the invention is predominantly composed of units resulting from C₅ monomers. C₅ monomers is understood to mean, according to the present invention and conventionally for a person skilled in the art, the monomers resulting from C₄ to C₆ oil cuts. For example, cis- and trans-1,3-pentadienes, pentenes, cyclopentadiene, cyclopentene, piperylene, isoprene, and the like, are suitable. This resin known as C₅ resin, predominantly composed of units resulting from C₅ monomers, can comprise, in addition to these units and in a minor amount, aliphatic or aromatic units or else units of aliphatic/aromatic type, that is to say based on aliphatic and/or aromatic monomers, other than C₅ monomers.

Preferably, for the invention, the content of hydrocarbon resin is within a range extending from 1 to 50 phr, preferentially from 5 to 30 phr.

Preferably in the composition of the external sidewall of the tyre of the invention, the amount of hydrocarbon resin is within a range extending from 7 to 25 phr, preferably from 8 to 20 phr.

Preferably, for the invention, the composition of the external sidewall of the tyre of the invention does not comprise another resin than the C₅ resin described above.

Plasticizing Oil

Preferably, for the invention, the composition of the external sidewall of the tyre of the invention does not comprise a plasticizing oil or comprises less than 25 phr of it.

Preferably, for the invention, the composition of the external sidewall of the tyre of the invention does not comprise a plasticizing oil.

Alternatively, the composition can comprise a plasticizing oil. In this case, the amount of plasticizing oil is preferentially within a range extending from more than 0 to 25 phr, preferably from 3 to 15 phr.

Any plasticizing oil, sometimes also known as extender oil, whether it is of aromatic ornon-aromatic nature, known for its plasticizing properties with regard to diene elastomers can be used. At ambient temperature (20° C.), these oils, which are more or less viscous, are liquids (that is to say, as a reminder, substances which have the ability to eventually assume the shape of their container), in contrast in particular to plasticizing hydrocarbon resins, which are by nature solids at ambient temperature.

Plasticizing oils selected from the group consisting of naphthenic oils (low or high viscosity, in particular hydrogenated or not), paraffinic oils, MES (Medium Extracted Solvates) oils, TDAE (Treated Distillate Aromatic Extracts) oils, mineral oils, vegetable oils, ether plasticizers, ester plasticizers, phosphate plasticizers, sulfonate plasticizers and the mixtures of these compounds are particularly suitable.

For example, mention may be made of those which contain between 12 and 30 carbon atoms, for example trioctyl phosphate. Mention may in particular be made, as examples of non-aqueous and water-insoluble ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may in particular be made, among the above triesters, of glycerol triesters, preferably predominantly composed (for more than 50%, more preferably for more than 80%, by weight) of an unsaturated C18 fatty acid, that is to say selected from the group consisting of oleic acid, linoleic acid, linolenic acid and the mixtures of these acids. More preferably, whether it is of synthetic origin or natural origin (case, for example, of sunflower or rapeseed vegetable oils), the fatty acid used is composed for more than 50% by weight, more preferably still for more than 80% by weight, of oleic acid. Such triesters (trioleates) having a high content of oleic acid are well known; they have been described, for example, in Application WO 02/088238 as plasticizing agents in tyre treads.

Preparation of the External Sidewall of the Invention

In order to prepare the external sidewall according to the invention, the elastomers are mixed, in a way known to a person skilled in the art, with the other components of the external sidewall, namely the fillers, the optional plasticizers, the wax, and also the crosslinking system and the optional other ingredients. A person skilled in the art will know how to adapt the order of incorporation of the ingredients (all at once or in several successive stages), the temperature and the compounding time.

Thus, for example, the following procedure is used for the tests: the elastomers, the fillers, the optional plasticizers, the wax and also the optional other ingredients, with the exception of the crosslinking system, are successively introduced into an internal mixer, approximately 70% (plus or minus 5%) filled and for which the initial vessel temperature is between 40° C. and 80° C. Thermomechanical working (non-productive phase) is then carried out in a stage which lasts in total approximately from 3 to 4 minutes, until a maximum “dropping” temperature of 150° C. is reached.

The mixture thus obtained is recovered and cooled and then the crosslinking system, for example sulfur, and an accelerator are incorporated on an external mixer (homofinisher) at 30° C., everything being mixed (productive phase) for an appropriate time (for example between 5 and 12 min).

According to another embodiment, all the components, including the crosslinking system, can be introduced successively into the internal mixer as described above. In this case, the mixing has to be carried out up to a “dropping” temperature of less than or equal to 130° C., preferably of less than or equal to 120° C. and in particular of less than or equal to 110° C.

In some alternative embodiments, one or more of the elastomers (diene and/or thermoplastic) used in the composition can be introduced in the form of a masterbatch or premixed with some of the components of the composition.

The compositions thus obtained are subsequently calendered, either in the form of plaques (thickness from 2 to 3 mm) or thin sheets of rubber, for the measurement of their physical or mechanical properties, or extruded in the form of tyre external sidewalls.

Use of the External Sidewall in a Pneumatic Tyre

The external sidewall described above is particularly well suited to use as finished or semi-finished product made of rubber, very particularly in a pneumatic tyre for a motor vehicle, such as a vehicle of two-wheel, passenger vehicle or industrial type.

It will be easily understood that, according to the specific fields of application, the dimensions and the pressures involved, the embodiment of the invention can vary; the external sidewall then comprises several preferred embodiments.

### Exemplary Embodiments of the Invention

The external sidewall described above can advantageously be used in pneumatic tyres for all types of vehicles, in particular passenger vehicles or industrial vehicles, such as heavy-duty vehicles.

By way of example, the single appended figure represents very diagrammatically (without observing a specific scale) a radial section of a pneumatic tyre in accordance with the invention.

This pneumatic tyre 1 comprises a crown 2 reinforced by a crown reinforcement or belt 6, two external sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is represented here fitted onto its wheel rim 9. The carcass reinforcement 7 is, in a way known per se, formed of at least one ply reinforced by “radial” cords, for example made of textile or metal, that is to say that these cords are positioned virtually parallel to one another and extend from one bead to the other so as to form an angle of between 80° and 90° with the median circumferential plane (plane perpendicular to the axis of rotation of the tyre which is located midway between the two beads 4 and passes through the middle of the crown reinforcement 6).

The internal wall of the pneumatic tyre 1 comprises an airtight layer 10, for example with a thickness equal to approximately 0.9 mm, on the side of the internal cavity 11 of the pneumatic tyre 1.

The pneumatic tyre according to the invention can use, for example for the composition of its external sidewall as defined above, a composition in accordance with the present invention.

The tyre provided with its external sidewall as described above is preferably produced before crosslinking (or curing). The crosslinking is subsequently carried out conventionally.

An alternative manufacturing form which is advantageous, for a person skilled in the art of pneumatic tyres, will consist, for example during a first stage, in depositing the airtight layer flat directly on a tyre-building drum, in the form of a skim of suitable thickness, before covering the latter with the remainder of the structure of the pneumatic tyre, according to manufacturing techniques well known to a person skilled in the art.

Tests

The properties of the elastomer compositions and of some of their constituents are characterized as indicated below.

Measurement of Ozone Resistance

The ozone resistance of the materials is measured according to the following method: after curing, 10 test specimens are placed on a trapezium at different elongations ranging from 10% to 100% in steps of 10% elongation. The “B15” test specimens result from an MFTR (known as Monsanto) plaque, the two beads of which located at the ends are used to hold the test specimen. The “B 15” test specimens have the following dimensions 78.5 mm*15 mm*1.5 mm. After exposure for 192 hours to a temperature of 38° C. and to an ozone content of 50 pphm (parts per hundred million), each facies is graded as a function of the number and of the depth of the cracks. This subjective grading ranges from 0 to 5 (0: no cracks; 1 to 4: presence of increasingly large and deep cracks; 5: breaking of the test specimen). The mean of the gradings of all the deformations (the lower the mean, the better the ozone performance) is selected as classification criterion.

Measurement of the Efflorescence Performance

After an operation of cutting out from the plaques of cured mixture, the test specimens with a thickness of 2.5 mm are stoved at 70° C. under air for 12 h. They are subsequently stoved at 40° C. under air for 4 weeks. After exiting from the stove and exposing to ambient temperature for 15 min, a mechanical stimulus is applied so as to reveal the efflorescence of the wax. In the present case, the mechanical stimulus consists of an operation of scraping the test specimen with a metal blade. The extent of the efflorescence phenomenon (white colouration of the surface) is subsequently evaluated by means of a subjective scale of values which is representative of the final appearance of the samples. The values of this subjective scale which were respectively obtained for the tested samples can vary from 0 to 3 and correspond to the “efflorescence grading”. These values, ranging from 0 to 3, correspond to the following aspects for the samples:

0: No efflorescence. The scraped surface remains black.

1: Light efflorescence.

2: Moderate efflorescence.

3: Total efflorescence. The scraped surface is white.

The lower the value, the better the appearance of the efflorescence performance, that is to say the weaker the efflorescence.

Evaluation of the Feeling to the Touch

The feeling to the touch is evaluated by means of a scale of values which is representative of the final appearance of the samples on conclusion of the preceding test. The values of this scale which were respectively obtained for the samples tested can vary from 0 to 3. These values ranging from 0 to 3 correspond to the following appearances for the samples:

0: The surface is non-tacky and non-greasy

1: The surface is slightly greasy

2: The surface is greasy and tacky

3: The surface is excessively greasy and tacky: the appearance is totally unacceptable

The lower the value, the better the feeling to the touch.

### Tests

External sidewall compositions containing ordinary elastomers, reinforcing fillers and additives corresponding to the controls (C1 to C11, Table 1) were prepared according to the methods known to a person skilled in the art and similarly to the preparation of the compositions of the invention described above. These control compositions were compared with compositions (I1 and I2 of Table 1) in accordance with the invention.

All of the compositions prepared are presented in Table 1. The contents are all expressed in phr.

TABLE 1

| Composition | C1 | C2 | I1 | I2 | C3 | C4 | C5 | C6 | C7 | C8 | C9 | C10 | C11 |
|---|---|---|---|---|---|---|---|---|---|---|---|---|---|
| NR (1) | 50 | 50 | 50 | 50 | 50 | 50 | 50 | 50 | 50 | 50 | 50 | 50 | 50 |
| BR (2) | 50 | 50 | 50 | 50 | 50 | 50 | 50 | 50 | 50 | 50 | 50 | 50 | 50 |
| Carbon black | 50 | 50 | 50 | 50 | 50 | 50 | 50 | 50 | 50 | 50 | 50 | 50 | 50 |
| (3) | | | | | | | | | | | | | |
| Oil (4) | 20 | 20 | 20 | 20 | 20 | 20 | 20 | 20 | 20 | 20 | 20 | 20 | 20 |
| Anti-ozone wax | 2 | 2 | 2 | 2 | 2 | 2 | 2 | 2 | 2 | 2 | 2 | 2 | 2 |
| (5) | | | | | | | | | | | | | |
| Product 1 (6) | — | 0.5 | 1.0 | 2.5 | 3.0 | — | — | — | — | — | — | — | — |
| Product 2 (7) | — | — | — | — | — | 1.0 | — | — | — | — | — | — | — |
| Product 3 (8) | — | — | — | — | — | — | 1.0 | — | — | — | — | — | — |
| Product 4 (9) | — | — | — | — | — | — | — | 1.0 | — | — | — | — | — |
| Product 5 (10) | — | — | — | — | — | — | — | — | 1.0 | — | — | — | — |
| Product 6 (11) | — | — | — | — | — | — | — | — | — | 1.0 | | | |
| Product 7 (12) | — | — | — | — | — | — | — | — | — | — | 3.0 | 5.0 | — |
| Product 8 (13) | — | — | — | — | — | — | — | — | — | — | — | — | 1.0 |
| Antioxidant (14) | 3 | 3 | 3 | 3 | 3 | 3 | 3 | 3 | 3 | 3 | 3 | 3 | 3 |
| Stearic acid | 1.1 | 1.1 | 1.1 | 1.1 | 1.1 | 1.1 | 1.1 | 1.1 | 1.1 | 1.1 | 1.1 | 1.1 | 1.1 |
| Zinc oxide | 2.5 | 2.5 | 2.5 | 2.5 | 2.5 | 2.5 | 2.5 | 2.5 | 2.5 | 2.5 | 2.5 | 2.5 | 2.5 |
| Accelerator (15) | 1.4 | 1.4 | 1.4 | 1.4 | 1.4 | 1.4 | 1.4 | 1.4 | 1.4 | 1.4 | 1.4 | 1.4 | 1.4 |
| Sulfur | 1.4 | 1.4 | 1.4 | 1.4 | 1.4 | 1.4 | 1.4 | 1.4 | 1.4 | 1.4 | 1.4 | 1.4 | 1.4 |

Table 1 references:
(1) NR Natural rubber
(2) Nd Butadiene rubber
(3) Carbon black N683 (BET equal to 36 m²/g; COAN 85 ml/100 g)
(4) MES oil from Exxon Mobil
(5) Antiozone wax, “Varazon 4959” from Sasol
(6) Product 1: Polyoxyethylene 20 cetyl ether, “Brij C20” from Croda, the HLB value of which is 15.7 and the molar mass of which is 1124 g/mol
(7) Product 2: Polyoxyethylene 10 cetyl ether,” Brij C10” from Croda, the HLB value of which is 12.9 and the molar mass of which is 683 g/mol
(8) Product 3: Polyoxyethylene 2 cetyl ether, “Brij C2” from Croda, the HLB value of which is 5.3 and the molar mass of which is 330 g/mol
(9) Product 4: Polyoxyethylene (9) of C₁₃-C₁₅ alcohols, “Synperonic A9” from Croda, the HLB value of which is 12.5 and the average molar mass of which is substantially equal to 610 g/mol
(10) Product 5: Polyoxyethylene (11) of C₁₃-C₁₅ alcohols, “Synperonic A11” from Croda, the HLB value of which is 13.9 and the average molar mass of which is substantially equal to 698 g/mol
(11) Product 6: Polyoxyethylene (40) monostearate, “Myrj S40” from Croda, the HLB value of which is 16.9 and the molar mass of which is 2044 g/mol
(12) Product 7: Poly(α-olefin), Vybar 103 from Baker Hughes
(13) Product 8: PEG-600, Pluriol E 600 from BASF
(14) 6PPD: N-(1,3-Dimethylbutyl)-N′-phenyl-para-phenylenediamin
(15) N-Cyclohexyl-2-benzothiazolesulfenamide, Santocure CBS from Solutia

The compositions were tested according to the tests described above for ozone, efflorescence and touch performance.

All of the results of the compositions tested are presented in Table 2. nm* indicates values not measured.

TABLE 2

| Performance | C1 | C2 | I1 | I2 | C3 | C4 | C5 | C6 | C7 | C8 | C9 | C10 | C11 |
|---|---|---|---|---|---|---|---|---|---|---|---|---|---|
| Ozone | 0.0 | 0.0 | 0.0 | 0.0 | 0.0 | nm* | nm* | nm* | nm* | nm* | nm* | 4.8 | 0.0 |
| Efflorescence | 3 | 3 | 1 | 0 | 0 | 2 | 3 | 3 | 3 | 3 | 2 | 0 | 2 |
| Touch | 0 | 0 | 0 | 1 | 3 | 0 | 0 | 0 | 0 | 0 | 0 | 0 | 0 |

The results presented in Table 2 show that only the compositions I1 and I2 in accordance with the invention make it possible to prevent the efflorescence and the impairment of touch, while exhibiting a very good ozone resistance.

1.-10. (canceled)

11. A tire provided with an external sidewall, the external sidewall comprising at least one composition based on at least:
from 15 to 70 phr of isoprene elastomer;
from 25 to 85 phr of butadiene elastomer;
from 10 to 100 phr of carbon black;
from 0.75 to 2.7 phr of polyethylene oxide derivative of general formula (Chem 1) 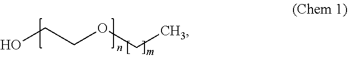
in which n is a number within a range extending from 20 to 25, and m is a number within a range extending from 13 to 17;
from 0.5 to 10 phr of antiozone wax; and
a crosslinking system.

12. The tire according to claim 11, wherein the content of isoprene elastomer is within a range extending from 30 to 60 phr.

13. The tire according to claim 11, wherein the content of butadiene elastomer is within a range extending from 40 to 70 phr.

14. The tire according to claim 11, wherein the total amount of carbon black is within a range extending from 20 to 60 phr.

15. The tire according to claim 11, wherein the polyethylene oxide derivative exhibits a number-average molecular mass Mn within a range extending from 1080 to 1412 g/mol.

16. The tire according to claim 11, wherein the polyethylene oxide derivative is such that n is a number within a range extending from 20 to 23.

17. The tire according to claim 11, wherein the polyethylene oxide derivative is such that m is equal to 15.

18. The tire according to claim 11, wherein the antiozone wax contains from 50% to 75% of linear alkanes comprising from 30 carbon atoms to 38 carbon atoms, with respect to a total amount of linear alkanes.

19. The tire according to claim 11, wherein the amount of antiozone wax is within a range extending from 0.7 to 5 phr.

20. The tire according to claim 11, wherein the at least one composition of the external sidewall further comprises a hydrocarbon resin.

21. The tire according to claim 11, wherein the polyethylene oxide derivative exhibits a number-average molecular mass Mn within a range extending from 1080 g/mol to 1200 g/mol.

22. The tire according to claim 11, wherein the polyethylene oxide derivative is such that n is equal to 20.

23. The tire according to claim 11, wherein the polyethylene oxide derivative has an HLB value of greater than 14.

24. The tire according to claim 11, wherein the polyethylene oxide derivative has an HLB value in the range extending from 14 to 20.

25. The tire according to claim 11, wherein the polyethylene oxide derivative has an HLB value in the range extending from 15 to 17.
